(19) United States
(12) Patent Application Publication
(10) Pub. No.: US 2024/0319338 A1
(43) Pub. Date: Sep. 26, 2024

(54) LiDAR-Based Object Recognition Method And Apparatus

(71) Applicants: Hyundai Motor Company, Seoul (KR); Kia Corporation, Seoul (KR)

(72) Inventors: Kyeong Eun Kim, Gunpo-si (KR); Kyeong Jin Jeon, Goyang-Si (KR); Jeong Su Park, Seoul (KR); Se Jong Heo, Anyang-Si (KR)

(21) Appl. No.: 18/533,526

(22) Filed: Dec. 8, 2023

(30) Foreign Application Priority Data
Mar. 20, 2023 (KR) 10-2023-0035799

(51) Int. Cl. G01S 7/48; G01S 17/89

(52) U.S. Cl. CPC G01S 7/4802; G01S 17/89

(57) ABSTRACT

A LiDAR-based object recognition method may be performed by an apparatus. The LiDAR-based object recognition method comprises obtaining surrounding environment data from at least one environmental sensor including a LiDAR sensor, obtaining object information for each sensor, including information of a LiDAR static object, based on data processing of the surrounding environment data from each sensor, determining validity of at least one unidentified class static object among the at least one LiDAR static object and outputting static object information according to the validity result.

### CROSS-REFERENCE TO RELATED APPLICATION

The present application claims priority to Korean Patent Application No. 10-2023-0035799, filed on Mar. 20, 2023, the entire contents of which is incorporated herein by reference in its entirety.

### TECHNICAL FIELD

The present disclosure relates to a LiDAR-based object recognition method and apparatus.

### BACKGROUND

Recognition is one of important factors in autonomous driving. Recognition (e.g., of surroundings, environment, obstacles, applicable road rules/signals) is essential for understanding a surrounding environment. To this end, an autonomous vehicle may be provided with one or more environmental sensor(s).

Data may be acquired from a plurality of different types of sensors. For example, data obtained from LiDAR, radar, camera, and the like may be analyzed (e.g., and combined) to achieve a more accurate understanding of the surrounding environment.

A recognition result may be used for a driving strategy, such as driving path determination, or the like, but may also be used for a precise positioning of a subject vehicle.

For example, the accurate position of the subject vehicle may be determined by matching information of recognized static objects obtained with precise map data. In this case, a static object used for precise positioning may be a formal object such as a guardrail, a curb, a building, a sign, or the like.

However, a plurality of atypical objects such as bush or tree may be included among the recognized surrounding static objects, and these objects may degrade accuracy of precise positioning.

### SUMMARY

The following summary presents a simplified summary of certain features. The summary is not an extensive overview and is not intended to identify key or critical elements.

Systems, apparatuses, and methods are described for LiDAR based object recognition. A method may comprise receiving surrounding environment data from at least one environmental sensor including a LiDAR sensor; determining, based on sensor-specific data processing of the surrounding environment data, object information associated with the at least one environmental sensor, wherein the object information comprises information about at least one LiDAR static object; determining, based on a contour of an occupancy map for the at least one LiDAR static object, a validity of at least one unidentified class static object of the at least one LiDAR static object; and outputting a map indicating, based on the validity, static object information.

Also, or alternatively, a LiDAR-based object recognition apparatus may comprise: at least one environmental sensor, comprising a LiDAR sensor, configured to obtain surrounding environment data; a non-transitory computer-readable medium storing a computer program for implementing a LiDAR-based object recognition method; and a processor configured to execute the computer program. The computer program, when executed, may configure the LiDAR-based object recognition apparatus to: determine, based on sensor-specific data processing of the surrounding environment data, sensor-specific object information comprising information about at least one LiDAR static object; determine, based on a contour of an occupancy map for the at least one LiDAR static object, a validity of at least one unidentified class static object of the at least one LiDAR static object; and output a map indicating, based on the validity, static object information.

These and other features and advantages are described in greater detail below.

### BRIEF DESCRIPTION OF DRAWINGS

FIG. 1 illustrates a method and apparatus for object recognition.

FIG. 2 illustrates an occupancy grid map time-accumulatively generated for LiDAR static objects.

FIG. 3 illustrates a class grid map generated for object information time-accumulatively obtained from environmental sensors.

FIG. 4 illustrates a result of assigning a class to cell clusters of an occupancy grid map based on a class grid map.

FIG. 5 schematically illustrates an example for determining validity of segments.

FIG. 6 schematically illustrates another example for determining validity of segments.

FIG. 7 illustrates a recognition result according to a comparative example.

FIG. 8 illustrates map data for a certain region in Korea.

FIG. 9 shows recognition results of a comparative example and an example for the region of FIG. 8.

### DETAILED DESCRIPTIONS

Specific examples of the present subject matter will be illustrated and described in the drawings, herein. However, this is not intended to limit the present subject matter to the specific examples. It should be understood that the present disclosure includes all modifications, equivalents, and replacements as would be understood by one skilled in the art.

The terms “module” and “unit” used in the present specification are used only for name division between components, and should not be construed as presupposing that they are physically or otherwise divided or separated or can be so divided or separated.

Terms including ordinals such as “first”, “second”, etc., may be used to describe various elements, but the elements are not limited by the terms. The terms are used only for the purpose of distinguishing one component from another component.

The term “and/or” may be used to include any combination of a plurality of items to be included. For example, “A and/or B” includes all three cases such as “A”, “B”, and “A and B”.

If a component is “connected” to another component, the component may be directly connected or connected to the other component, but it should be understood that another component may exist there-between, unless specified otherwise (e.g., by explicitly stating a “directly connected”).

The terminology used herein is for the purpose of describing particular examples only and is not intended to be limiting of the present disclosure. A singular expression includes a plural expression unless the context clearly indicates otherwise. In the present application, it should be understood that the term “include” or “have” indicates that a feature, a number, a step, an operation, a component, a part, or a combination thereof described in the specification is present, but does not exclude the possibility of presence or addition of one or more other features, numbers, steps, operations, components, parts, or combinations thereof in advance.

Unless otherwise defined, all terms used herein, including technical or scientific terms, have the same meaning as that generally understood by those skilled in the art to which the present disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In addition, the unit or the control unit is a term widely used for naming a controller for controlling a vehicle specific function, and does not mean a generic function unit. For example, a (e.g., each) unit and/or control unit may include a communication device and/or component configured to communicate with another controller and/or a sensor so as to control a function in charge (e.g., of the other controller and/or sensor), a memory storing an operating system and/or a logic command, input/output information, and the like, and one or more processors configured to perform determination, operation, judgement, and the like for controlling the function in charge.

The processor may include a semiconductor integrated circuit and/or electronic devices configured to perform at least one or more of comparison, determination, calculation, and/or communication to achieve a programmed function. For example, the processor may be one or more of a computer, a microprocessor, a CPU, an ASIC, and a circuitry (logic circuits), or a combination thereof.

The non-transitory computer-readable medium includes all types of storage devices in which data that can be read by a computer system is stored. For example, the memory may include at least one of a flash memory type, a hard disk type, a micro type, a card type (e.g., a Secure Digital (SD) card or an eXtream Digital (XD) card), and the like, and a Random Access Memory (RAM), a Static RAM (SRAM), a Read-Only Memory (ROM), a Programmable ROM (PROM), an Electrically Erasable PROM (EEPROM), a Magnetic RAM (MRAM), a magnetic disk, and an optical disk type.

The non-transitory computer-readable medium may be electrically connected to the processor, and the processor may be configured to retrieve and/or record data from the non-transitory computer-readable medium. The non-transitory computer-readable medium and the processor may be integrated or may be physically separated.

First, the accompanying drawings will be briefly described, and examples of the present disclosure will be described in detail with reference to the drawings.

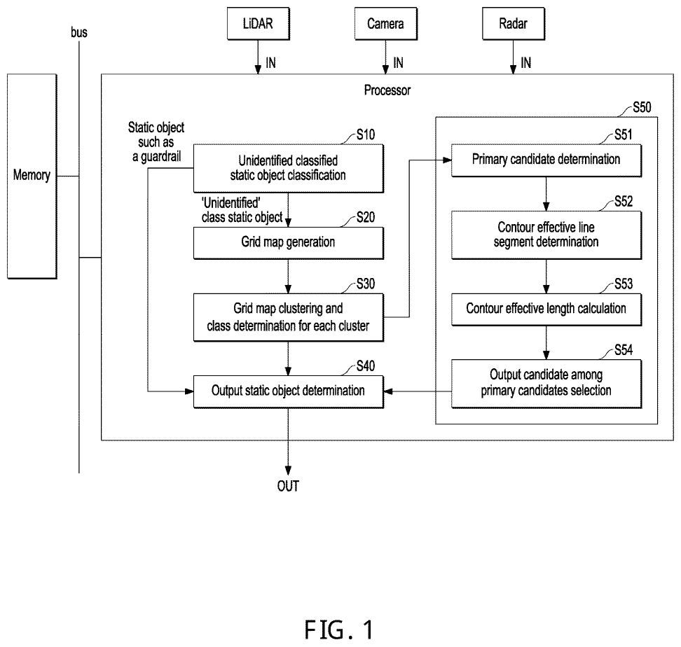

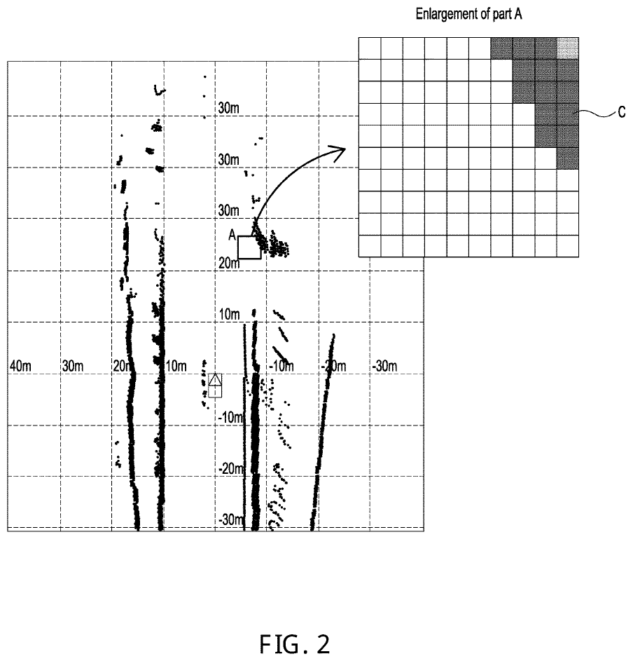

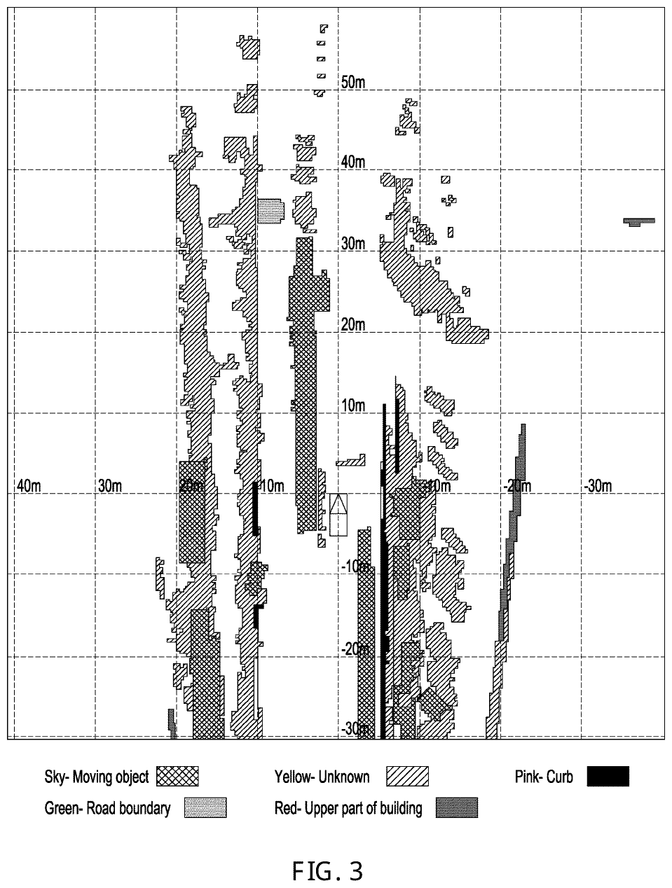

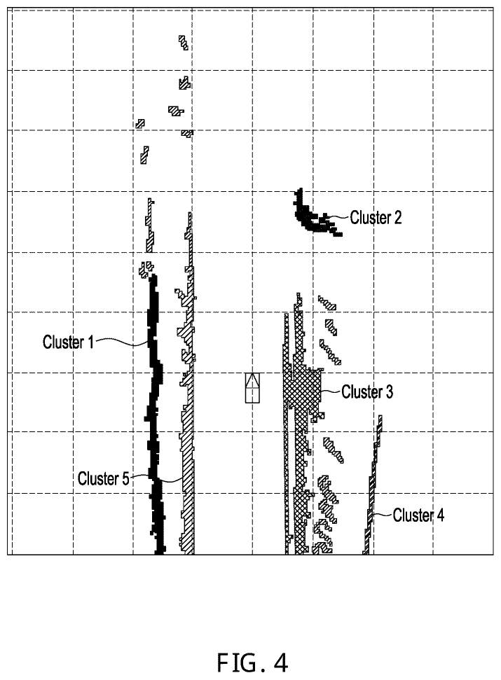

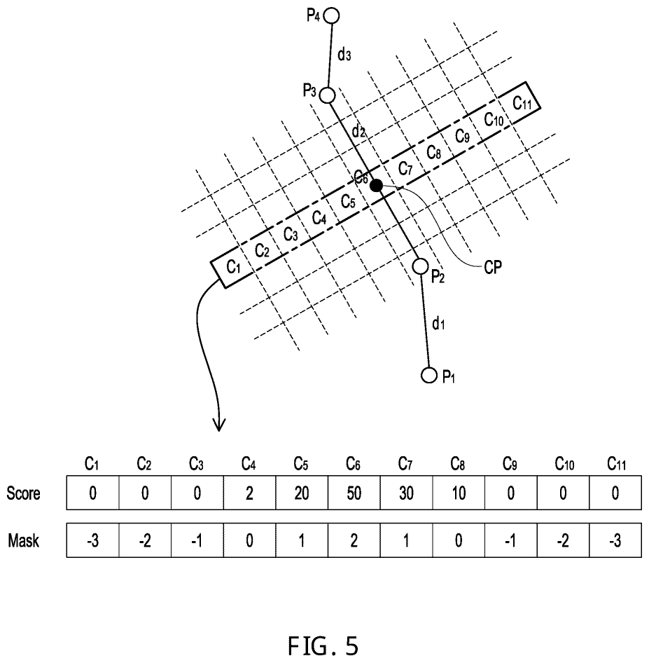

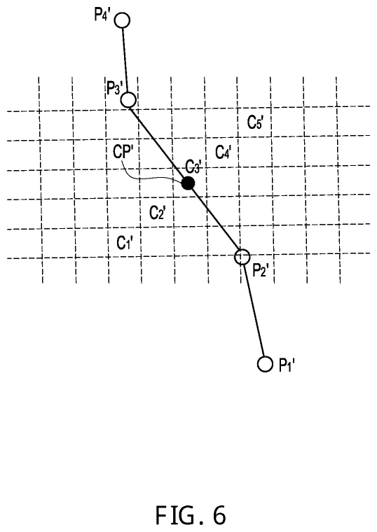

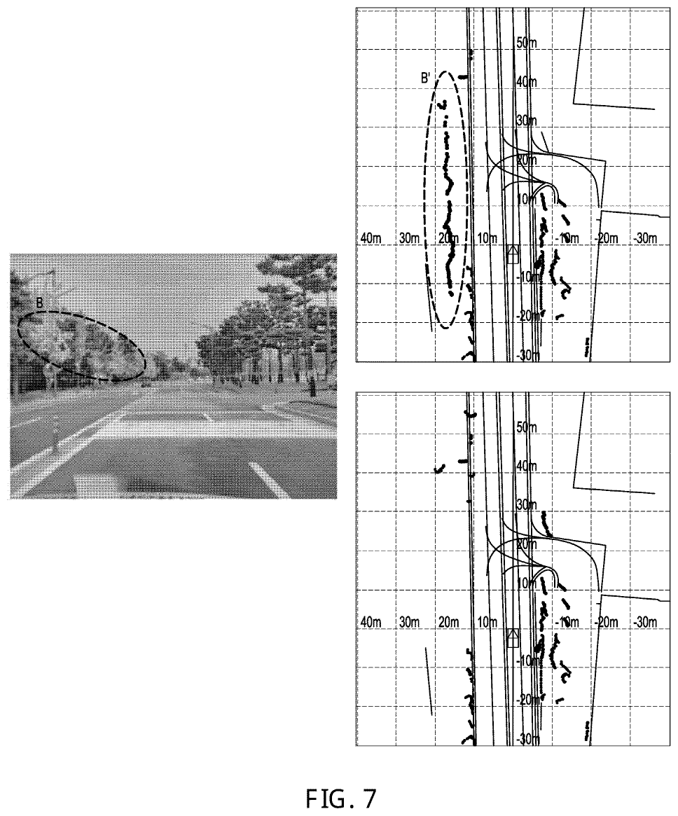

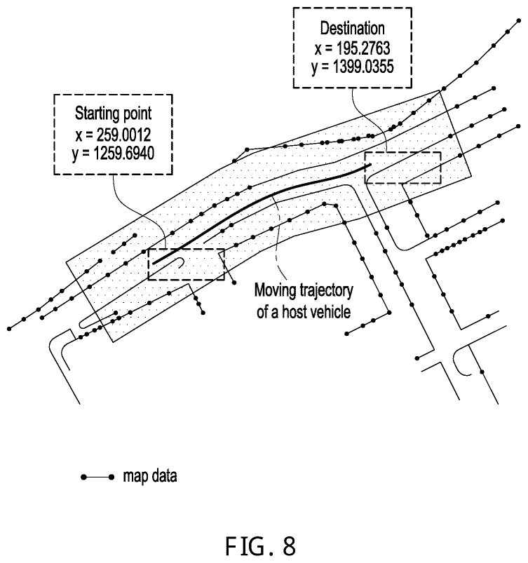

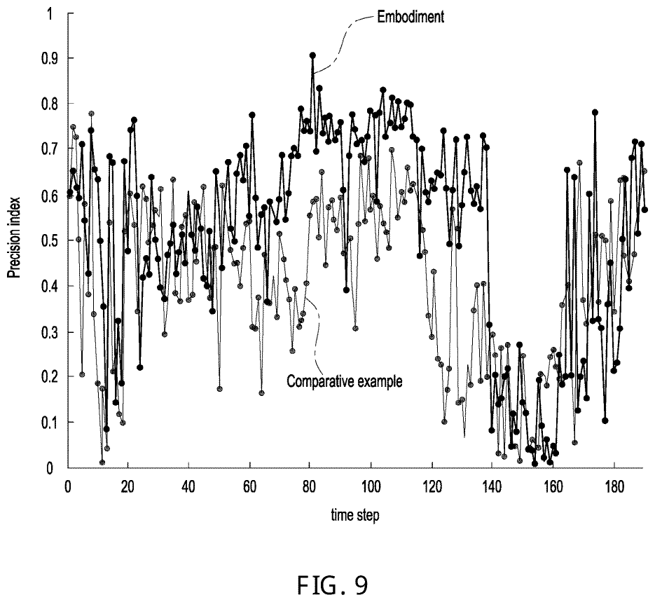

FIG. 1 illustrates a method and apparatus for object recognition. FIG. 2 illustrates an occupancy grid map that time-accumulatively generated with respect to LiDAR static objects, and FIG. 3 illustrates a class grid map that is generated with respect to object information that time-accumulatively obtained from environmental sensors. FIG. 4 illustrates a result of assigning a class based on a class grid map to cell clusters of an occupancy grid map, and FIG. 5 schematically illustrates an example for determining a validity of a segment. Further, FIG. 6 schematically illustrates another example for determining a validity of segments, and FIG. 7 illustrates a recognition result according to a comparative example. FIG. 8 illustrates map data for a certain region in the Republic of Korea, and FIG. 9 illustrates recognition results of a comparative example and for the region of FIG. 8.

As shown in FIG. 1, the LiDAR-based object recognition apparatus includes environmental sensors, a memory, and a processor.

Environmental sensors may include one or more of LiDAR, camera, radar, and the like, each of which may include a single or multiple homogeneous sensors. The environmental sensors may include at least one LiDAR. For example, the LiDAR may include one or more of a roof LiDAR, a front LiDAR, a side LiDAR, and a rear LiDAR installed in a vehicle.

The memory may store various data and a computer program (e.g., instructions stored on a non-transitory computer readable medium) configured for implementing the object recognition method disclosed herein.

The processor may perform the object recognition method by reading and executing the program from the memory.

The flowchart illustrated in the processor of FIG. 1 represents a method of recognizing an object.

Surrounding environment data may be obtained from environmental sensors. The surrounding environment data may be processed via data processing set for each sensor. Object information may be obtained by processing the data from each sensor. The object information may be determined and/or received by and/or input to the processor.

For example, raw data obtained from the LiDAR sensor may be in a form of a point cloud, and may be processed via data processing processes, such as pre-processing, clustering, object detection, object tracking, and/or classification. The data processing may result in LiDAR-based object information.

The LiDAR-based object information may include, for example, one or more of a shape, a location, a speed, or class information of each object. The shape information may include segments (e.g., contour of the corresponding object) connecting the outer points of the corresponding object. Obtaining such object information from the LiDAR point cloud is well known in the art, and thus a detailed description thereof will be omitted.

Also, camera-based object information and radar-based object information may be obtained by processing camera and radar data through data processing set for each corresponding sensor. The camera-based object information may include, for example, shape, position, speed, class information, and the like of each object. The radar-based object information may include, for example, a location and a speed of each object, and information on whether the object is a moving object or a stationary object.

The data processing for each sensor may be performed by the processor of FIG. 1, and/or may be performed by one or more separate processors (e.g., associated with one or more of the at least one sensor).

The LiDAR-based object information may include recognized static objects, and/or may include class information on each static object.

As an example, the classes may include classes for formal objects such as “guardrail”, “curb”, “building”, “sign”, “building-upper-portion”, and the like, and/or an “unknown” or “unidentified” class. The unidentified class may be given to a recognized static object, among the static objects detected by the LiDAR and/or based on the LiDAR sensor data, that does not correspond to any one of the predetermined formal classes.

In step S10, the processor may distinguish a static object, among the static objects, of an unidentified class (hereinafter, referred to as an “unidentified static object”).

Step S40 may be directly applied to objects corresponding to the formal objects (e.g., a determination of a class of a static object assigned a formal object class may be directly output). The unidentified static objects may be selected as output candidates based on a validity determination and then may be determined as final output objects and output based on that determination, as described herein.

First, in step S20, the LiDAR static objects may be mapped to the grid map to form an occupancy grid map.

The occupancy grid map may include past time frame data as well as current time frame data, and may be obtained by continuously accumulating frame data over time.

FIG. 2 illustrates an occupancy grid map. The enlargement of part A from the overall occupancy grid map shows individual cells C with cell occupancy values indicated by shading of black (occupied with a static object), and white or gray (background/unoccupied).

A score of each cell C of the occupancy grid map is determined according to a temporal history of being occupied by a static object.

For example, if a static object continuously occupies a cell C for a plurality of time frames, the score of the corresponding cell C may be cumulatively increased based on (e.g., with) each time frame.

In the example of FIG. 2, the bright white cell C has a higher score than the gray cell C, which has a higher score than the black cells C.

FIG. 3 illustrates a class grid map. A class grid map may also, or alternatively, be generated based on class information included in the object information for each sensor.

A class grid map may be accumulated and formed over time, and a class of one cell may be determined to a class which more occupies among classes of objects occupying the corresponding cell.

For example, if it the “road boundary” class is determined for a cell 5 times and the “building-upper-portion” class is determined for the cell 2 times from data accumulated over time for the cell, the class of the corresponding cell may be determined as “road boundary” class.

For the class grid map, the class information may use not only a single type of sensor data but heterogeneous sensor data. That is, for example, the LiDAR data and the camera data may be used together for the class grid map.

In the occupancy grid map and/or the class grid map, the form of the grid map is not limited. In the present example, the grid map is formed of square cells, but it is natural that the shape and/or size thereof may be changed.

In step S30, clustering may be performed on the occupancy grid map. A plurality of clusters may be obtained (e.g., determined) via (e.g., based on, by) the clustering. The clustering may be performed based on a predetermined distance with respect to cells whose scores are equal to or greater than a predetermined value.

For example, the predetermined distance may be a length of one side of one cell. In this case, adjacent cells having sufficient scores are clustered into a same cluster.

By applying the clustering only to cells having a score equal to or greater than the predetermined value, cells that are temporarily indicated as being occupied by a static object (e.g., in one or two time frames) may be excluded from the target.

The class of the corresponding cluster may be determined based on the class grid map (e.g., formed based on clustering on the occupancy grid map).

The class of the cluster may be determined to be dominant among the classes of the cells of the corresponding cluster. For example, in cells of a cluster, multiple classes may be determined as the class of the cluster.

FIG. 4 illustrates a clustering result for an occupancy grid map. As shown in FIG. 4, clusters 1 to 5 may be determined, and a class for each cluster may be determined according to the above-described method. In this case, an unidentified class may be assigned to a cluster whose class is not determined. For the purpose of explanation, cluster 1 may be determined as class a, cluster 2 may be determined as class b, cluster 3 may be determined as class c, cluster 4 may be determined as class d, and cluster 5 may be determined as an unidentified class.

In step 50, a validity of the unidentified class object, among the LiDAR static objects, may be determined and an output candidate may be selected according to the validity determination.

In step S51, a candidate may be selected from the LiDAR static objects. The candidate may be an unidentified class object and may have a contour corresponding to where an average score value of cells in the occupancy grid map are equal to or greater than a first threshold value. A primary candidate may be determined by excluding clusters which are related to a “building-upper-portion”class, for example, from the clusters of the LiDAR static objects.

In step S52, effective segment(s) of the contour may be determined for the primary candidate. For example, a validity of segments of the contour may be determined, and segment(s) determined to be valid may be determined as effective segment(s).

In step S53, the summed-length (hereinafter, referred to as “effective length”) of the effective segments of the corresponding contour may be determined and/or calculated.

In step S54, if a ratio of the effective length to the total length of the contour segments (hereinafter, referred to as “effective segment ratio”) is equal to or greater than a second threshold, the output candidate may be selected.

Here, the validity of the line segment may be determined based on whether a score distribution of related cells is similar to a shape of a static object. For example, if the scores of the related cells are large in the center-point of a corresponding segment and cells adjacent thereto and are small as being away from the center-point, the corresponding segment may be determined as an effective segment.

That is, whether the segment is the effective segment is determined according to the scores of the cells included in a cluster to which the contour belongs among cells arranged on both sides perpendicularly to the center-point of the corresponding segment in the occupancy grid map. As an example, the effective segment may be determined based on an inner product value of the scores of the cells and a kernel mask (e.g., a 1D Gaussian kernel mask) being equal to or greater than a third threshold value.

Here, elements of the kernel mask may have a smaller value as a distance from the center-point increases (e.g., values may decrease away from the center-point of the kernel mask).

FIG. 5 illustrates validity determination of a line segment P2-P3 under the assumption of a LiDAR static object having outer points P1 to P4.

As shown in FIG. 5, in cells perpendicularly arranged on both sides with respect to the center-point CP of a segment P2-P3, cells of a corresponding cluster are C1 to C11, and the scores of the cells are sequentially 0, 0, 0, 2, 20, 50, 30, 10, 0, 0, and 0.

The element values of the kernel mask may be, for example, sequentially −3, −2, −1, 0, 1, 2, 1, 0, −1, −2, and −3. The kernel mask in this example has the largest element value of 2 corresponding to the center-point, and decreases as the distance from the kernel mask increases to both sides.

In the example of FIG. 5, the inner product values of the cell scores and the kernel mask are determined as in Equation 1 below.

$$0 + 0 + 0 + 0 + 20 + 100 + 30 + 0 + 0 + 0 + 0 = 150 \qquad [ Equation 1 ]$$

That is, in the example of FIG. 5, the inner product value is 150.

The larger the inner product values of the scores of the cells and the kernel mask, the smaller the variance of the scores, and the opposite means that the variance is large. In the present example, a segment whose inner product value (e.g., indicating the degree of variance of scores) is equal to or greater than the third threshold may be determined as an effective segment.

In the case of the static object, since the variance of the static object may be increased according to the length of a segment, the third threshold may be determined to allow a large variance as the length of the segment is increased.

For example, the third threshold may be determined as shown in Equation 2 below.

$$Threshold = max ( γ , \frac{η}{d} ) \qquad [ Equation 2 ]$$

Here, γ is a minimum setting value for the third threshold, f is a constant, and d represents a segment length.

FIG. 6 is another example of related cells arranged perpendicularly on both sides with respect to the center-point CP′ of a segment P2′-P3′.

In the example of FIG. 6, the related cells (e.g., cells belonging to a cluster of cells corresponding to a segment P2′-P3′) are C1′ to C5′.

The validity of the segment P2′-P3′ of FIG. 6 is determined by the inner product value of the above-described 1D Gaussian kernel mask and the scores of the cells C1′ to C5′.

Referring back to FIG. 5, according to the validity determination as described above, it is assumed that the segment P1-P2 and the segment P2-P3 are valid segments and the segment P3-P4 is not valid segment, and the valid segment ratio of the contour will be described.

The effective segment ratio (VSR) of the contour of FIG. 5 is a ratio of the summed length of the effective segments to the entire length of the segments, and thus may be determined by Equation 3 below.

$$V S R = ( {d}_{1} + {d}_{2} ) \div ( {d}_{1} + {d}_{2} + {d}_{3} ) \qquad [ Equation 3 ]$$

In step S54, a contour having an effective segment ratio equal to or greater than a second threshold may be selected as an output candidate.

The contour having the effective segment ratio less than the second threshold may be likely to be an atypical static object. Such an object may be excluded from an output target in step S54.

Among the primary candidates, candidates having an effective segment ratio equal to or greater than a second threshold value may be ranked according to the size of the effective segment ratio, and the ranking may be used for determining a final output target.

In step S40, a final output static object may be determined from the output candidates (objects selected, from the unidentified static objects, as the output candidates in step S54) and from the objects classified as the formal objects in step S10.

A ranking according to the size of the effective segment ratio may be considered in the determination of the final output static object.

The processor may determine and/or output an output object, from the static objects, except for the atypical object(s). Also, or alternatively, for example, the output static objects may be used for precise positioning via map matching.

In the present example, the validity determination and the effective segment ratio may be used to remove the atypical static object(s), but may also be used to evaluate the reliability of the corresponding object.

The reliability evaluation need not be limited to static objects of an unidentified class.

For example, in the road boundary, the higher the effective segment ratio of the contour, the higher the probability that the contour is an actual road boundary, so that the effective segment ratio may be used as the reliability evaluation index.

FIG. 7 shows a result of object recognition according to a comparative example.

The left image of FIG. 7 shows a camera image of a corresponding scene, the right upper image shows an object recognition result according to the comparative example, and the right lower image shows an object recognition result according to an example of the present disclosure.

As shown in FIG. 7, it can be seen that static objects corresponding to trees as atypical objects in the camera image were recognized and output in the comparative example, but were excluded in the example of the present disclosure.

Also, FIG. 8 illustrates map data for a certain region in Korea, and FIG. 9 illustrates recognition results of a comparative examples and an example for the region of FIG. 8.

The host vehicle was equipped with an object recognition devices of the comparative example and the example of the present disclosure. The object recognition device of the comparative example and the example of the present disclosure performed recognition on surrounding objects while the host vehicle moved along a moving trajectory from a starting point to a destination point.

FIG. 9 shows a precision index for a comparative example and an example of the present disclosure, and the precision index is defined as a ratio of the number of recognized static objects (that is, in an image and used for map matching) to the total number of static objects in a corresponding section (e.g., of the map).

As shown in FIG. 9, the precision index according to the example of the present disclosure is higher than that of the comparative example.

The present disclosure aims to solve at least one of the problems of the related art described herein, and provide other advantages.

The present disclosure provides a LiDAR-based object recognition method and apparatus capable of effectively recognizing and processing an atypical object. The LiDAR-based object recognition method comprises steps of obtaining surrounding environment data through at least one environmental sensor including a LiDAR sensor, obtaining object information for each sensor including information on at least one LiDAR static object through data processing for each sensor for the surrounding environment data and determining validity of at least one unidentified class static object among the at least one LiDAR static object, and outputting static object information according to the determined result.

In at least one example, the step of outputting the static object information comprises a primary candidate determining step of determining at least one primary candidate among the at least one unidentified class static object, and an output candidate determining step of determining an output candidate according to a result of determining validity of a contour of the at least one primary candidate.

In at least one example, the method further comprises generating a class grid map based on an occupancy grid map for static objects obtained time-accumulatively through the LiDAR sensor and class information obtained time-accumulatively from the object information for each sensor, and determining a class based on the class grid map with respect to at least one cluster on the occupancy grid map, wherein the primary candidate determining step includes a step of selecting, in the occupancy grid map, candidates according to scores of cells in which contours of the at least one unidentified class static object overlap each other, and a step of excluding, among the selected candidates, a candidate associated with a cluster of a class of an upper portion of a building.

In at least one example, the step of selecting the candidates may include a step of selecting, as the candidates, scores of cells having an average value greater than or equal to a first threshold.

In at least one example, the output candidate determining step includes a step of determining an effective segment for determining validity of each segment of a contour of the at least one primary candidate, a step of determining an effective length for determining whether a ratio of a summed length of effective segments to an entire length of the contour segment is equal to or greater than a second threshold, and a step of selecting the at least one primary candidate as the output candidate when the ratio is equal to or greater than the second threshold.

In at least one example, the step of determining the effective segment includes a step of determining, in the occupancy grid map, according to scores of cells included in a cluster to which the contour belongs among cells arranged on both sides perpendicularly to a center-point of each segment.

In at least one example, the step of determining according to the scores of the cells include a step of determining according to whether an inner product value of a 1-D Gaussian kernel mask and scores of cells included in the cluster is equal to or greater than a third threshold.

In at least one example, the elements of the 1-D Gaussian kernel mask have smaller values that decrease as a distance from the center-point increases.

In at least one example, the third threshold value decreases as the length of each segment increases.

In at least one example, the step of outputting the static object information further comprises a step of determining a final output static object between a static object of a class other than the unidentified class among the at least one LiDAR static object and the determined output candidate.

There is provided a LiDAR-based object recognition apparatus comprising at least one environmental sensor including a LiDAR sensor for obtaining data of a surrounding environment, a non-transitory computer-readable medium storing a computer program for a LiDAR-based object recognition method, and a processor retrieving the computer program from the non-transitory computer-readable medium and executing the computer program, wherein the LiDAR-based object recognition method includes steps of: obtaining object information for each sensor including information on at least one LiDAR static object through a data processing for each sensor on the surrounding environmental data, determining a validity of at least one unidentified class static object among the at least one LiDAR static object(s), and outputting static object information according to the determination result of the validity.

In the object recognition apparatus, outputting the static object information includes a primary candidate determining step for determining at least one primary candidate of the at least one unidentified class static objects, and an output candidate determining step for determining an output candidate according to a result of determining validity of a contour of the at least one primary candidate.

In the object recognition apparatus, the processor is further configured to generate a class grid map based on an occupancy grid map for static objects obtained time-accumulatively through the LiDAR sensor and class information obtained time-accumulatively from the object information for each sensor, and determine a class based on the class grid map with respect to at least one cluster on the occupancy grid map, wherein the primary candidate determining step includes a step of selecting a candidate configured to select a candidate according to scores of cells in which a contour of the at least one unidentified class static object overlaps in the occupancy grid map, and a step of excluding a candidate associated with a cluster of a class of an upper portion of a building among the selected candidates.

In the object recognition apparatus, the step of selecting of the candidate may include a step of selecting, as the candidate, scores of cells having an average value greater than or equal to a first threshold value.

In the object recognition apparatus, the output candidate determining step includes an effective segment determining step of determining validity for each segment of a contour of the at least one primary candidate, an effective length determining step of determining whether a ratio of a summed length of effective segments to an entire length of the contour segment is equal to or greater than a second threshold value, and a step of selecting the at least one primary candidate as the output candidate when the ratio is equal to or greater than the second threshold value.

In the object recognition apparatus according to at least one example of the present disclosure, the effective segment determining step includes a step of determining, in the occupancy grid map, according to scores of cells included in a cluster to which the contour belongs, among the cells arranged on both sides perpendicularly to a center-point of each segment.

In the object recognition apparatus, the step of determining according to the scores of the cells includes a step of determining whether an inner product value of the scores of the cells and a 1-D Gaussian kernel mask included in the cluster is equal to or greater than a third threshold.

In the object recognition apparatus, the elements of the 1D Gaussian kernel mask have smaller values as a distance from a center-point increases.

In the object recognition apparatus, the third threshold value decreases as a length of each segment increases.

In the object recognition apparatus, the step of outputting further includes a step of determining a final output static object between the determined output candidate and a static object of a class other than the unidentified class among the at least one LIDAR static object(s).

It is possible to effectively recognize and process an atypical object.

It is prevented that the host vehicle is incorrectly positioned due to an atypical static object.

What is claimed is:

1. A method comprising:
receiving surrounding environment data from at least one environmental sensor including a LiDAR sensor;
determining, based on sensor-specific data processing of the surrounding environment data, object information associated with the at least one environmental sensor, wherein the object information comprises information about at least one LiDAR static object;
determining a validity of at least one unidentified class static object of the at least one LiDAR static object; and
outputting, based on the validity, static object information for the at least one LiDAR static object.

2. The method of claim 1, further comprising:
determining at least one primary candidate of the at least one unidentified class static object; and
determining an output candidate based on a validity of a contour of the at least one primary candidate, wherein the static object information corresponds to the output candidate.

3. The method of claim 2, further comprising:
generating a class grid map based on:
an occupancy grid map for static objects determined time-accumulatively based on data from the LiDAR sensor, and
class information determined time-accumulatively from the object information associated with the at least one environmental sensor; and
based on the class grid map and for at least one cluster on the occupancy grid map, determining a class of the at least one cluster, wherein the determining the at least one primary candidate comprises:
based on scores of cells, overlapping with at least one unidentified class static object and a contour in the occupancy grid map, selecting candidates for the at least one primary candidate; and
excluding, as the at least one primary candidate among the selected candidates, a candidate associated with a cluster of a class of an upper portion of a building.

4. The method of claim 3, wherein the selecting the candidates is based on cells having scores with an average value greater than or equal to a first threshold.

5. The method of claim 3, further comprising:
determining a validity of each segment of a contour of the at least one primary candidate;
determining, based on the validity of each segment of the contour, an effective length of valid segments of the contour; and
based on a ratio of the effective length to an entire length of the contour being equal to or greater than a second threshold, selecting the at least one primary candidate as the output candidate.

6. The method of claim 5, wherein the determining the validity of each segment is based on scores of cells in a cluster to which the contour belongs and arranged on either side, perpendicularly, to a center-point of the segment.

7. The method of claim 6, wherein the determining the validity of each segment comprises determining whether an inner product of a 1-D Gaussian kernel mask and the scores of the cells is equal to or greater than a third threshold.

8. The method of claim 7, wherein elements of the 1-D Gaussian kernel mask have values that decrease with a distance from a center-point of the 1-D Gaussian kernel mask.

9. The method of claim 7, wherein the third threshold value decreases with a length of the segment.

10. The method of claim 2, wherein the outputting the map indicating the static object information comprises determining a final output static object between a static object, of a class other than the unidentified class and from the at least one LiDAR static object, and the determined output candidate.

11. A LiDAR-based object recognition apparatus, comprising:
at least one environmental sensor, comprising a LiDAR sensor, configured to obtain surrounding environment data;
a non-transitory computer-readable medium storing a computer program for implementing a LiDAR-based object recognition method; and
a processor configured to execute the computer program, wherein the computer program, when executed, configures the LiDAR-based object recognition apparatus to:
determine, based on sensor-specific data processing of the surrounding environment data, sensor-specific object information comprising information about at least one LiDAR static object;
determine a validity of at least one unidentified class static object of the at least one LiDAR static object; and
output, based on the validity, static object information for the at least one LiDAR static object.

12. The apparatus of claim 11, wherein the computer program, when executed, further configures the LiDAR-based object recognition apparatus to:
determine at least one primary candidate of the at least one unidentified class static object; and
determine an output candidate based on a validity of a contour of the at least one primary candidate, wherein the static object information corresponds to the output candidate.

13. The apparatus of claim 12, wherein the computer program, when executed, further configures the LiDAR-based object recognition apparatus to:
generate a class grid map based on:
an occupancy grid map for static objects determined time-accumulatively based on data from the LiDAR sensor, and
class information determined time-accumulatively from the object information associated with the at least one environmental sensor; and
based on the class grid map and for at least one cluster on the occupancy grid map, determine a class of the at least one cluster; and
determine the primary candidate by:
based on scores of cells, overlapping with at least one unidentified class static object and a contour in the occupancy grid map, selecting candidates for the at least one primary candidate; and
excluding, as the at least one primary candidate among the selected candidates, a candidate associated with a cluster of a class of an upper portion of a building.

14. The apparatus of claim 13, wherein the selecting the candidates is based on cells having scores with an average value greater than or equal to a first threshold value.

15. The apparatus of claim 13, wherein the computer program, when executed, further configures the LiDAR-based object recognition apparatus to:
determine a validity of each contour segment of a contour of the at least one primary candidate;
determine, based on the validity of each contour segment, an effective length of valid contour segments; and
based on a ratio of the effective length to an entire length of the contour being equal to or greater than a second threshold value, select the at least one primary candidate as the output candidate.

16. The apparatus of claim 15, wherein the computer program, when executed, further configures the LiDAR-based object recognition apparatus to: determine the validity of each contour segment based on scores of cells in a cluster to which the contour belongs and arranged on either side, perpendicularly, to a center-point of the contour segment.

17. The apparatus of claim 16, wherein the computer program, when executed, further configures the LiDAR-based object recognition apparatus to: determine the validity of each contour segment based on whether an inner product value of a 1-D Gaussian kernel mask and the scores of the cells is equal to or greater than a third threshold.

18. The apparatus of claim 17, wherein elements of the 1-D Gaussian kernel mask have values that decrease with a distance from a center-point of the 1-D Gaussian kernel mask.

19. The apparatus of claim 17, wherein the third threshold value decreases with a length of each segment.

20. The apparatus of claim 12, wherein the computer program, when executed, further configures the LiDAR-based object recognition apparatus to: output the map indicating the static object information based on determining a final output static object between a static object, of a class other than the unidentified class and from the at least one LiDAR static object, and the determined output candidate.
